(19) United States
(12) Patent Application Publication
(10) Pub. No.: US 2018/0084002 A1
(43) Pub. Date: Mar. 22, 2018

(54) MALICIOUS HYPERLINK PROTECTION

(71) Applicant: Re-Sec Technologies LTD., Pardes-Hana (IL)

(72) Inventor: Oren Shnitzer, Pardes-Hana (IL)

(21) Appl. No.: 15/270,838

(22) Filed: Sep. 20, 2016

(51) Int. Cl. H04L 29/06

(52) U.S. Cl. CPC H04L 63/1441

(57) ABSTRACT

A method for malicious hyperlink protection, the method may include receiving, by a risk management computer, a first file that is aimed to a computer of a user; storing the first file in a memory of the risk management computer; searching, by the risk management computer, for a hyperlink that is included in the first file and links to target content that is included in a target website; when finding the hyperlink then evaluating, at least partially by the risk management computer, whether the hyperlink imposes a risk; preventing the user from utilizing the hyperlink for accessing the target content before a completion of the evaluating of whether the hyperlink imposes the risk; and wherein when evaluating that the hyperlink imposes the risk then: modifying the file to provide a modified file; wherein the modifying of the file comprises deleting the hyperlink or replacing the hyperlink with a modified hyperlink; wherein the modified hyperlink links to a web entity that differs from the target website; and sending the modified file to the computer of the user.

### BACKGROUND

Today's digital traffic very often may contain hyperlinks embedded in documents (e.g. Microsoft Office, PDF) and emails. These hyperlinks often serve a legitimate purpose such as directing the user to a relevant site that contains additional information, or allowing a user to follow up on a received document or email. However, these links are also commonly used for non-legitimate purposes such as luring the user in malicious phishing schemes, or directing the user to malicious sites that try to exploit vulnerabilities in their web browser. Using malicious hyperlinks may often server as the first step when trying to infiltrate an organization.

### SUMMARY

There may be provided a method for malicious hyperlink protection, the method may include: receiving, by a risk management computer, a first file that may be aimed to a computer of a user; storing the first file in a memory of the risk management computer; searching, by the risk management computer, for a hyperlink that may be included in the first file and links to target content that may be included in a target website; when finding the hyperlink then evaluating, at least partially by the risk management computer, whether the hyperlink imposes a risk; preventing the user from utilizing the hyperlink for accessing the target content before a completion of the evaluating of whether the hyperlink imposes the risk; and wherein when evaluating that the hyperlink imposes the risk then: modifying the file to provide a modified file; wherein the modifying of the file may include deleting the hyperlink or replacing the hyperlink with a modified hyperlink; wherein the modified hyperlink links to a web entity that differs from the target website; and sending the modified file to the computer of the user.

The web entity may be a landing page; wherein the method may include generating the landing page to may include an alert to be displayed to the user when the user utilizes the modified hyperlink.

The web entity may be a landing page; wherein the method may include generating the landing page to may include an alert to be displayed when the user utilizes the modified hyperlink; wherein the landing page may be associated with a script that may include instructions for accessing the target content that may be included in the target website after a predefined delay from a start of the displaying of the alert.

The web entity may be a landing page; wherein the method may include generating the landing page to may include a request for confirming an access to the target content in the target website; wherein the landing page may be associated with a script that may include instructions for accessing the target content in the target website when the user confirmed the access to the target content in the target website.

The web entity may be a landing page; wherein the method may include generating the landing page to may include a sanitized version of the target content or may include a link to the sanitized version of the target content.

The sanitized version of the target content may be a non-interactive content of the target content.

The web entity may be a landing page; wherein the method may include generating the landing page while concealing from the user a name of the target website.

The method may include generating the modified hyperlink not to include any identifier of the target website.

There may be provided a method for malicious hyperlink protection, the method may include: receiving, in a risk management computer, a first file that may be aimed to a computer of a user; storing the first file in a memory of the risk management computer; searching, by the risk management computer, for a hyperlink that may be included in the first file and links to target content that may be included in a target website; when finding the hyperlink then modifying the file to provide a modified file; wherein the modifying of the file may include replacing the hyperlink with a modified hyperlink; wherein the modified hyperlink, once utilized by the user, cause the computer of the user to (a) trigger an evaluation of whether the hyperlink imposes a risk and (b) trigger, following the evaluation, a risk mitigation operation when evaluating that the hyperlink imposes the risk; and sending the modified file to the risk management computer of the user.

The risk mitigation operation may include preventing the computer of the user from accessing the target content in the target website.

The risk mitigation operation may include accessing a landing page that may include an alert to be displayed to the user when the user utilizes the modified hyperlink.

The risk mitigation operation may include accessing a landing page that may include an alert to be displayed when the user utilizes the modified hyperlink; wherein the landing page may be associated with a script that may include instructions for accessing the target content that may be included in the target website after a predefined delay from a start of the displaying of the alert.

The risk mitigation operation may include accessing a landing page that may include a request for confirming an access to the target content in the target website; wherein the landing page may be associated with a script that may include instructions for accessing the target content in the target website when the user confirmed the access to the target content in the target website.

The risk mitigation operation may include accessing a landing page that may include a sanitized version of the target content or may include a link to the sanitized version of the target content.

The sanitized version of the target content may be a non-interactive content of the target content.

There may be provided a computer program product that stores instructions that once executed by a computer cause the computer to execute the steps of receiving, by a risk management computer, a first file that may be aimed to a computer of a user; storing the first file in a memory of the risk management computer; searching, by the risk management computer, for a hyperlink that may be included in the first file and links to target content that may be included in a target website; when finding the hyperlink then evaluating, at least partially by the risk management computer, whether the hyperlink imposes a risk; preventing the user from utilizing the hyperlink for accessing the target content before a completion of the evaluating of whether the hyperlink imposes the risk; and wherein when evaluating that the hyperlink imposes the risk then: modifying the file to provide a modified file; wherein the modifying of the file may include deleting the hyperlink or replacing the hyperlink with a modified hyperlink; wherein the modified hyperlink links to a web entity that differs from the target website; and sending the modified file to the computer of the user.

There may be provided a computer program product that stores instructions that once executed by a risk management computer cause the risk management computer to execute the steps of receiving a first file that may be aimed to a computer of a user; storing the first file in a memory of the risk management computer; searching for a hyperlink that may be included in the first file and links to target content that may be included in a target website; when finding the hyperlink then modifying the file to provide a modified file; wherein the modifying of the file may include replacing the hyperlink with a modified hyperlink; wherein the modified hyperlink, once utilized by the user, cause the computer of the user to (a) trigger an evaluation of whether the hyperlink imposes a risk and (b) trigger, following the evaluation, a risk mitigation operation when evaluating that the hyperlink imposes the risk; and sending the modified file to the risk management computer of the user.

There may be provided a risk management computer that may include a memory, a communication module and a processor, wherein the memory may be configured to receive and store a first file that may be aimed to a computer of a user; wherein the processor may be configured to search for a hyperlink that may be included in the first file and links to target content that may be included in a target website; when finding the hyperlink then at least assist in evaluating whether the hyperlink imposes a risk; preventing the user from utilizing the hyperlink for accessing the target content before a completion of the evaluating of whether the hyperlink imposes the risk; and wherein when evaluating that the hyperlink imposes the risk then the processor may be configured to modify the file to provide a modified file; wherein the modifying of the file may include deleting the hyperlink or replacing the hyperlink with a modified hyperlink; wherein the modified hyperlink links to a web entity that differs from the target website; and wherein the communication module may be configured to send the modified file to the computer of the user.

There may be provided a risk management computer that may include a memory, a communication module and a processor, wherein the memory may be configured to receive and store a first file that may be aimed to a computer of a user; wherein the processor may be configured to search for a hyperlink that may be included in the first file and links to target content that may be included in a target website; when finding the hyperlink then the processor may be configured to modify the file to provide a modified file; wherein the modifying of the file may include replacing the hyperlink with a modified hyperlink; wherein the modified hyperlink, once utilized by the user, cause the computer of the user to (a) trigger an evaluation of whether the hyperlink imposes a risk and (b) trigger, following the evaluation, a risk mitigation operation when evaluating that the hyperlink imposes the risk; and sending the modified file to the risk management computer of the user.

A risk management system computer is a computer that can manage risks—especially attempt to reduce risk resulting from malicious hyperlinks. The computer may include a memory, a processor and a communication module. The communication module may include circuits for transmitting and/or receiving information using any known method of transmission and/or reception. The processor may be a hardware processor including but not limited to a general purpose processor, a dedicated hardware processor, an ASIC, an FPGA, and the like.

The memory may include multiple sectors. The first file may be stored in a first sector of the memory that is not accessible to the computer of the user—either temporarily or permanently. The preventing the user from utilizing the hyperlink for accessing the target content before a completion of the evaluating of whether the hyperlink imposes the risk may involve storing the first file in the first sector. The modified file (or the first file—when determining that the first file can be accessed by the computer of the user without modification)—may be stored in a second sector of the memory—although this is not necessarily so.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of a risk management computer such as a server and its environment;

FIG. 2 illustrates an example of a method;

FIG. 3 illustrates an example of a data structure;

FIG. 4 illustrates a method according to various embodiments of the invention;

FIG. 5 illustrates an example of a method;

FIG. 6 illustrates an example of a method; and

FIG. 7 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

The terms URL and target website are used in an interchangeable manner.

The terms target address

Format conversion/transformation is used in order to protect from known and unknown malware embedded within digital documents.

The present invention presents a method for protecting the users in an organization from malicious URLs. The system blocks malicious hyperlinks that are embedded inside mail messages and documents (e.g. Microsoft office, PDF) by replacing the original, possibly malicious, hyperlink with a sanitized version of it. The sanitized hyperlink sends the user to a safe landing page. The landing page (that is maintained by the system) analyses the target location and presents information to the user based on the target site analysis results, reputation, and the security policy selected by the organization.

For example, the system may be deployed in an organization that allows its users to use only hyperlinks from the internal organization's network (intranet). In this case the system will replace any external hyperlink with a link to a static page that informs the user that he was directed to an external web site, in violations of the security policy of the organization.

In another scenario, an organization may opt to allow its users to receive hyperlinks for external web sites, but only after they have been analyzed and validated as safe. In this case the original hyperlink will be replaced with a link to a dynamic web page. When the user will click on the hyperlink he will be sent to the dynamic web page. The web page will perform an analysis of the target site, and only if the site is not detected as malicious it will automatically direct the user to that site.

Embedding hyperlinks in documents and emails

A hyperlink that is embedded in a document or an email is a special element that is supported by that document format. Each document format may have a different internal representation for hyperlinks.

An email—An email message is comprised of several parts as described in RFC 821. Essentially, an email is usually comprised of a message body and optionally one or more attachments. The message body may be sent as a plain text message (which doesn't offer any special support for hyperlinks) or as an HTML message. Other mail formats include Microsoft TNF. The common way of sending a hyperlink through the mail is in the HTML view. In that view the hyperlink is usually embedded as an HREF object. Here is an example of an HTML HREF element.

<link href=“/images/branding/product/ico/googleg_lodpico” rel=“shortcut icon”>

When this link appears in the HTML message, it is usually displayed as a blue text with an underline.

When a link is embedded in a Microsoft Office document it is embedded as a special HYPERLINK object, as part of the document. It usually appears as a blue text with an underline.

A PDF document may contain hyperlinks. They are included as LINK objects. They can have the common visual look of blue underlined text, but it is also very common to see other visual styles in such links.

Protecting from malware by performing format transformations

When an organization receives a document from customers, other vendors, or job candidates, it is faced with a dilemma. From the business perspective, these documents need to be read by someone in the organization. However, when an employee opens a document from an external source he becomes susceptible to an array of potential attack vectors.

Malware can be delivered to a target in the organization in the form of a document that contains one of the following—an exploit, a malicious macro, an embedded file or a hyperlink.

An exploit—a segment in the binary form of the document that is specifically design to take advantage of a known exploit in software that is used to read or edit this document. For example, there are hundreds of known vulnerabilities in current and past versions of products such as Microsoft word, Adobe acrobat reader, etc. vulnerabilities that have been remediated in the latest version of the products are often made public and published in designated sites. These vulnerabilities are often still relevant because when dealing with large organizations some computers will not be kept 100% up to date with every software update that was published.

A malicious macro—Macros are small pieces of code written in specific script languages (such as Visual basic, Java script) that are embedded into a document and begin running when the document is loaded or a specific trigger occurs. Macros can be very powerful; they can invoke OS commands, activate and use other programs, read and write files, etc. A common attack method is to embed a malicious macro that takes advantage of a known exploit in the application. This is because there is a very large number of exploits that exist in those scripting areas. Another problem with macros (or any other executable code) is that it is computationally impossible to predict what a code will do under every scenario. That are many tools that help obfuscate a code so that its true actions remain hidden from someone just browsing the source code.

An embedded file that is either malicious or contains a malicious code—while the common policy for organizations is to block an email that contains an executable attachment, it is often possible to embed such an executable inside an innocent looking document and request the user to double click that when reading the document.

A hyperlink that when followed (for example by clicking on it) will direct the user to a malicious web location. Malicious locations may attempt to steal the user's personal information by impersonating another, legitimate, site, try to execute some code on the user's computer by exploiting a vulnerability in his web browser, or user other social and technical engineering methods to achieve their goal.

Transforming the document to another format in a way that disables those attack vectors by the three following steps:
a. Recreating the document without the exploits.
b. Removing macros based on a set of predefined rules—remove unsinged macros or all.
c. Recursively processing embedded objects within the file and removing or processing them.

There is provided a risk management computer and instructions that are executed on a computer of a user. For simplicity of explanation the risk management computer is referred to a s a server. The instructions are referred to as a client.

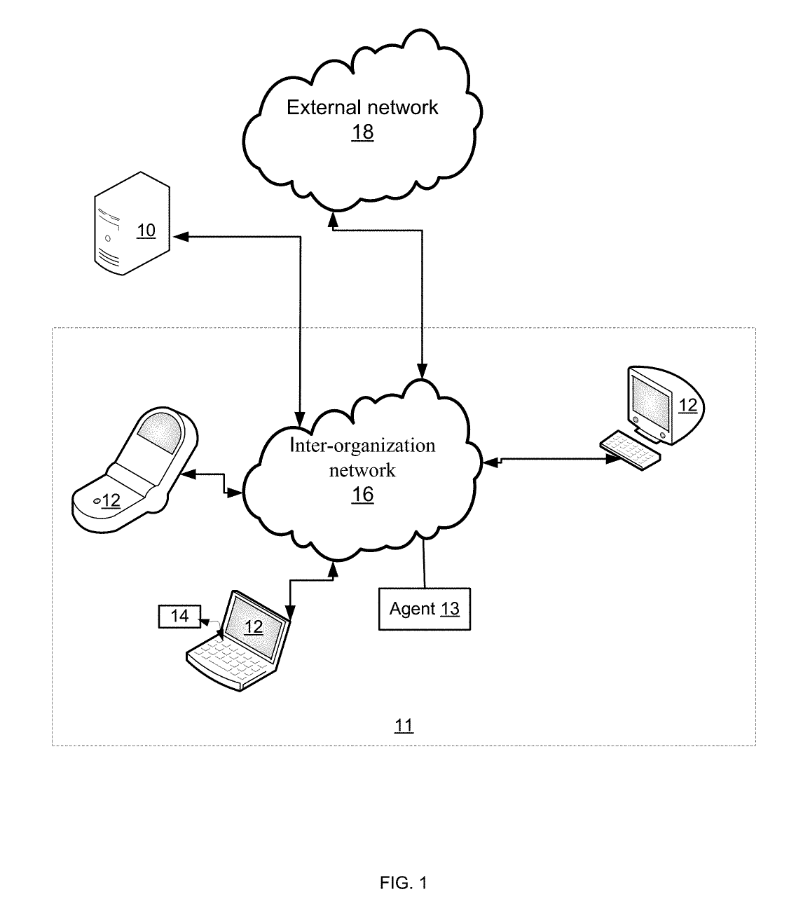

FIG. 1 illustrates a server 10, agent 13, multiple computers 12 of users that host clients 14, an inter-organization network 16, and an external network 18 that is external to organization 11.

Server 10 is coupled to multiple computers 12 that belong to organization 11. Server 10 is coupled to the multiple computers 12 via inter-organization network 16. Server 10 and multiple computers 12 may be coupled, directly or via inter-organization network 16 to external network 18. The external network 18 may be the Internet—but this is not necessarily so. It is noted that server 10 may be coupled to multiple computers 12 via the external network 18.

Server is configured to protect multiple computers 12 from malicious hyperlinks included in files that are sent to one or more of the multiple computers.

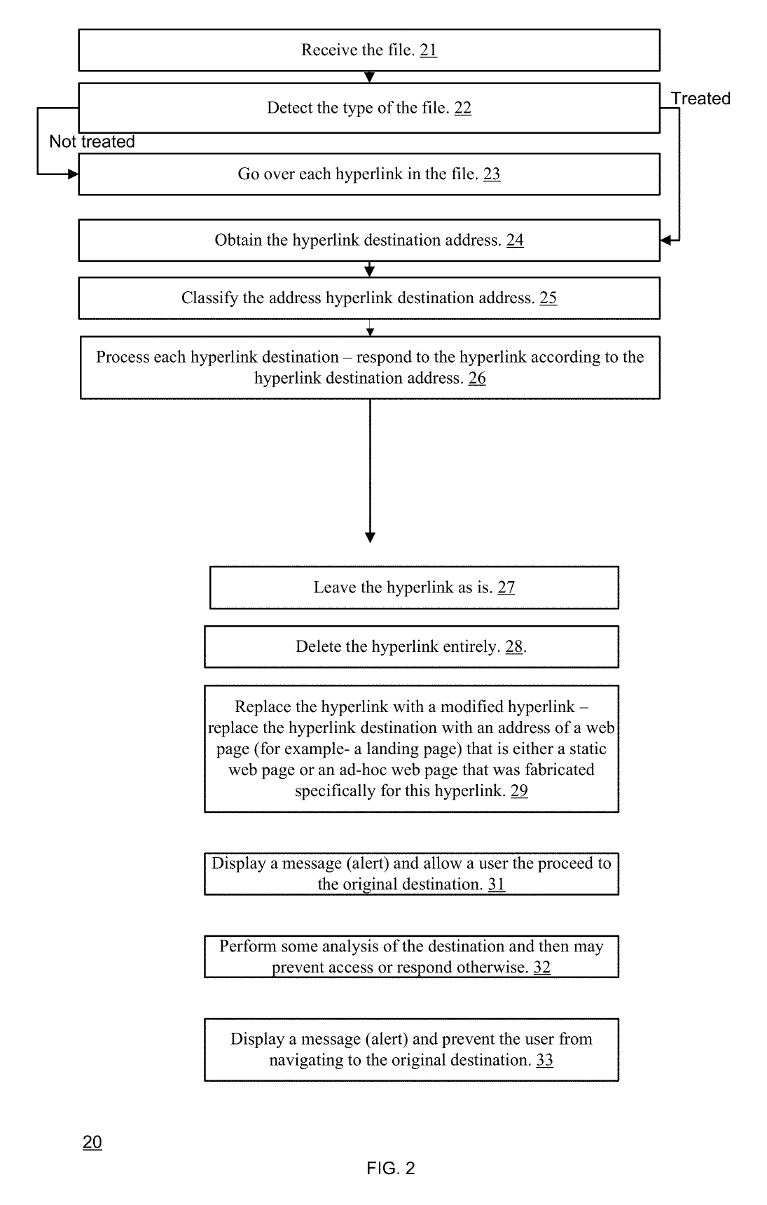

The clients 14 submit to the server 10 files that should be processed, and the server 10 will receive the file (step 21 in FIG. 2) and returns the processed files back to the clients 14 or delivers them to the destination directly (via SMB file share for example).

The server 10 may receive a file in any format—for example—one of the following formats: Office Word Document (doc, docx, docm), Excel document (xls, xlsx, xlsm), Powerpoint presentation (ppt, pptx, pptm), PDF or a mail message (as an SMTP MIME formatted message).

The server 10 may return the file in its original format or transform it to a different format (for example PDF->DOCX). Optionally, the server may transform the document twice: to an intermediate format and back to the original (PDF->DOCX->PDF).

The transformed file (also referred to as modified file) will look similar to the original document but each hyperlink in the document will be modified according to a predefined policy that was created by the organization's IT department.

The server 10 will perform the following steps—(see FIG. 2) detect (step 22) the type of the file, go over each hyperlink in the file (step 23), for each hyperlink in the file—obtain the hyperlink destination address (step 24), classify (step 25) the address hyperlink destination address, and process each hyperlink destination—respond to the hyperlink according to the hyperlink destination address (step 26).

Detect the type of the file (step 22)—detection may be based on the file extension, metadata that is supplied by the client or the content of the file.

Go over each hyperlink in the file (step 23—a control step—for repeating steps 23-26 for each hyperlink in the file).

Obtain the hyperlink destination address (step 24)—in accordance with the file format extract the hyperlink target address.

Classify (step 25) the address as one of the following classifications: trusted, untrusted and malicious—classification may be done by matching the site to a set of 3 regular expressions that correspond to each of the classifications. Any site that is not matched to any of the classification could be treated as untrusted by default. For example, links that lead into organizational—intranet destinations (such as hyperlinks to a page in the company's own web site) may be treated as trusted.

Process (step 26) each hyperlink according to its classification. Possible actions done on each hyperlink may include:
a. Leave the hyperlink as is (step 27).
b. Delete the hyperlink entirely (step 28).
c. Replace (step 29) the hyperlink with a modified hyperlink—replace the hyperlink destination with an address of a web page (for example—a landing page) that is either a static web page or an ad-hoc web page that was fabricated specifically for this hyperlink.

For each hyperlink that was modified to point to a (fabricated) landing page the page may act in one of the following ways: display (step 31) a message (alert) and allow a user the proceed to the original destination, (ii) perform (step 32) some analysis of the destination and then may prevent access or respond otherwise, (ii) display (step 33) a message (alert) and prevent the user from navigating to the original destination.

Display a message (e.g. the message may warn the user that he is about to navigate to a possibly unsafe or malicious site). The user is allowed (possibly after a short duration in order to make sure he reads the message) to select and navigate to the original destination, as an alternative the user may be automatically directed to the original destination of the hyperlink after a short while.

The page may be designed to perform some analysis of the destination when the page is first created and/or when a user first navigates to it and/or each time a user navigates to it. The analysis of the destination may be done using a web classification tool. Commercial tools for this purpose are fairly common (such as Google's VirusTotal, McAfee SiteAdvisor, sandbox solutions etc.). The contents of the landing page may depend on the outcome of the analysis. If the destination is deemed to be malicious then the user can be prohibited from proceeding. On other cases the user may be presented with a message that summarizes the analysis outcome of the page and either automatically sends him to the destination or after he performs an action such as clicking on a button.

The page may display a message (e.g. explaining to the user that navigation to the destination was blocked for security reasons) and prevent the user from navigating to the original hyperlink destination.

There may be provided a system that may include a server and one or more collection agents. One or more collection agent may be hosted by the server.

The server—one or more computers linked together for load balancing and high availability. The server processes each incoming file and modifies its URLs based on the security policy. The server maintains a table of known URLs that will be used by our web server when generating the ad-hoc landing page.

Agents (collection agents)—each collection agent intercepts incoming traffic from a specific data channel, send it for analysis and transformations, and allow the processed file to pass onward to the next step in the chain. Examples for such collection agents are (i) an agent that intercepts emails, (ii) an agent that intercepts FTP traffic, (iii) an agent that is deployed on the end-points and intercepts files coming from thumb drives or other USB peripheral devices, and/or (iv) agents that exposes an API that can be called from automatic systems in the organization.

An agent that intercepts emails—incoming mail is usually processed in several stages. It is passed from the organization's firewall to the spam filter and then to the local mail exchange server. The users can then access their mailbox from their local exchange server. The interception agent can be placed as part of this chain (usually between the spam filter and the local mail server). When an email is received by the email agent it will be processed by the system and the processed product will be sent to the next stage.

An agent that intercepts FTP traffic—The usual setup for an organizational FTP consists of an FTP server that has an external address and can be accessed by trusted parties. The FTP server allows its users to upload or download files to designated folders in the server. These files are then accessible to internal users in the form of shared folders on file servers.

An agent that is deployed on the end-points and intercepts files coming from thumb drives or other USB peripheral devices. When a file is intercepted by one of those agents it is first sent to the main server for processing. The server will process the file and send the result (which could be the original file, a transformed version of the file, or nothing if the entire file need to be blocked) back to the collection agent. The collection agent will pass the resulting file onward to the next stage.

An agent that exposes an API that can be called from automatic systems in the organization. Such an API may be designed as a web REST API or other programmatically method for externalizing a service.

The server responds to client requests (typically this server will only be available for users from within the corporate network) and provides them with a landing page that corresponds to a URL that was received in one of the documents processed by the system and the security policy that was selected for it. When a user receives a file after it was processed, some of the hyperlinks in that file may be a modified version of the original hyperlink that actually point to our internal web server instead of directly to the destination URL. The behavior of the web server is dictated by the contents of the known URLs table that is maintained by the server.

Mapping between the address of the landing page and the original address of the web page.

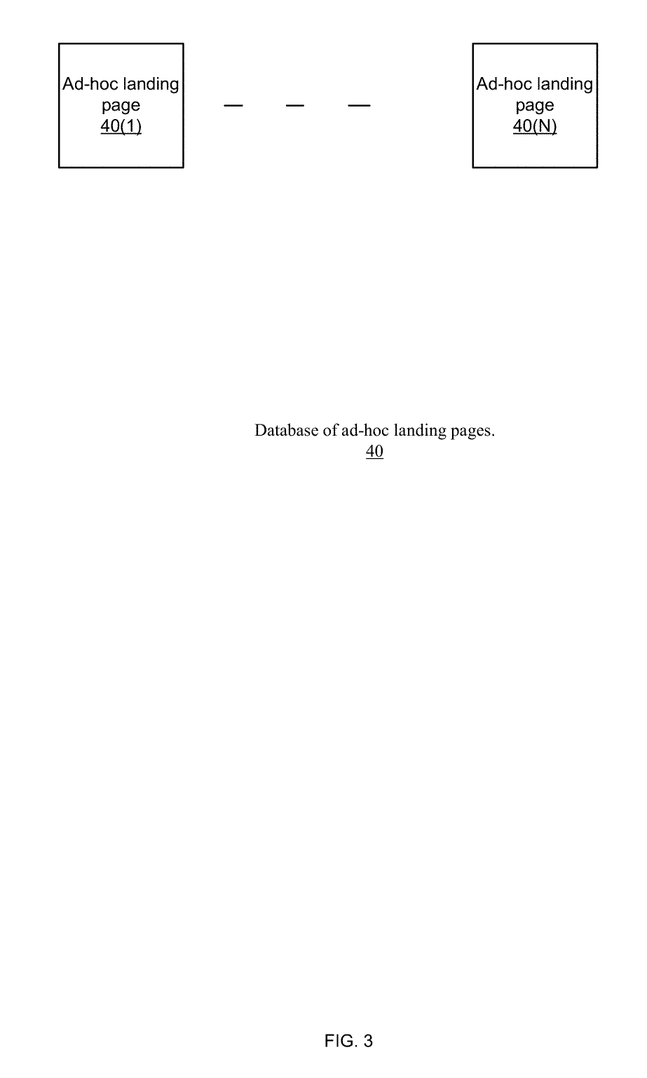

The system maintains a database (denoted 40 in FIG. 3) of ad-hoc landing pages (denoted 40(1)-40(N), N being a positive integer). Each ad-hoc page is related to a specific URL that the system encountered and removed from a document that was processed.

One method of managing the set of landing pages is by embedding the original destination address as a parameter in the landing page's address. For example—if the original hyperlink was pointing to “www.unknown.com” then the landing page's address may be in the form of “www.landingpage.internal company domain/www.unknown.com”. In this case when the user navigates to the target site, our system will receive the request since it will be configured to receive all requests send to “www.landingpage.internal company domain”.

In order to prevent more sophisticated users from knowing the original hyperlink destination, the system can either encrypt the web address so that the system can understand the address, but the user can't—or otherwise conceal the original hyperlink destination.

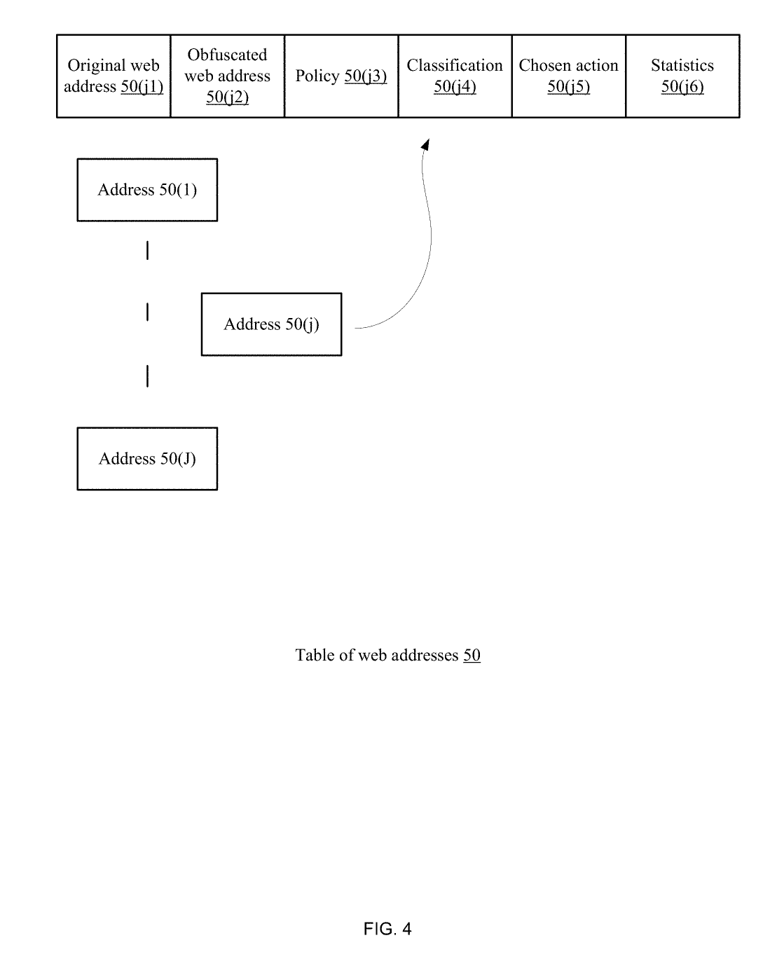

Another option is to keep a table (denoted 50 in FIG. 4) of all the web addresses (50(1)-50(J)) that the system received as embedded hyperlinks.

For each address (50(j), index j ranges between 1 and J) maintain at least some of the following information:

a. Original web address 50(j1)
b. Obfuscated web address 50(j2)—a random string that uniquely identifies this entry in the table and can be used by the user to access the URL for this entry
c. The policy 50(j3) that was chosen for treating this web page. The policy may be dependent on various factors such as the user that received the document that contained this request or the channel/type of agent that the document arrived from.
d. Classification 50(j4) of this web page (no analyzed yet, analyzed on date X and clean/suspicious/infected).
e. The chosen action 50(j5) for the web page based on the policy and classification of this page. Possible actions include: block, allow with message, analyze once, analyze on each access.
f. Statistics 50(j6) and related information about the web page such as when a user last visited it, which users visited this page, etc.

### Agent Side

When a new file is received by an agent it will send that file to the server.

As an optional step the agent may analyze the file and check if it from a format that is treated by system (e.g. PDF, DOC, DOCX, PPT, PPTX, XLS, XLSX). If the file is not from one of those formats, then pass it to the user as-is or perform any other predefined action.

The server will process the file and send back an outcome (‘clean’/‘modified’) and optionally the processed file back to the agent.

If the outcome was ‘clean’ then the file is released to the user

Else replace the original file with the modified version we received from the server and release this version of the file to the user.

Server Side

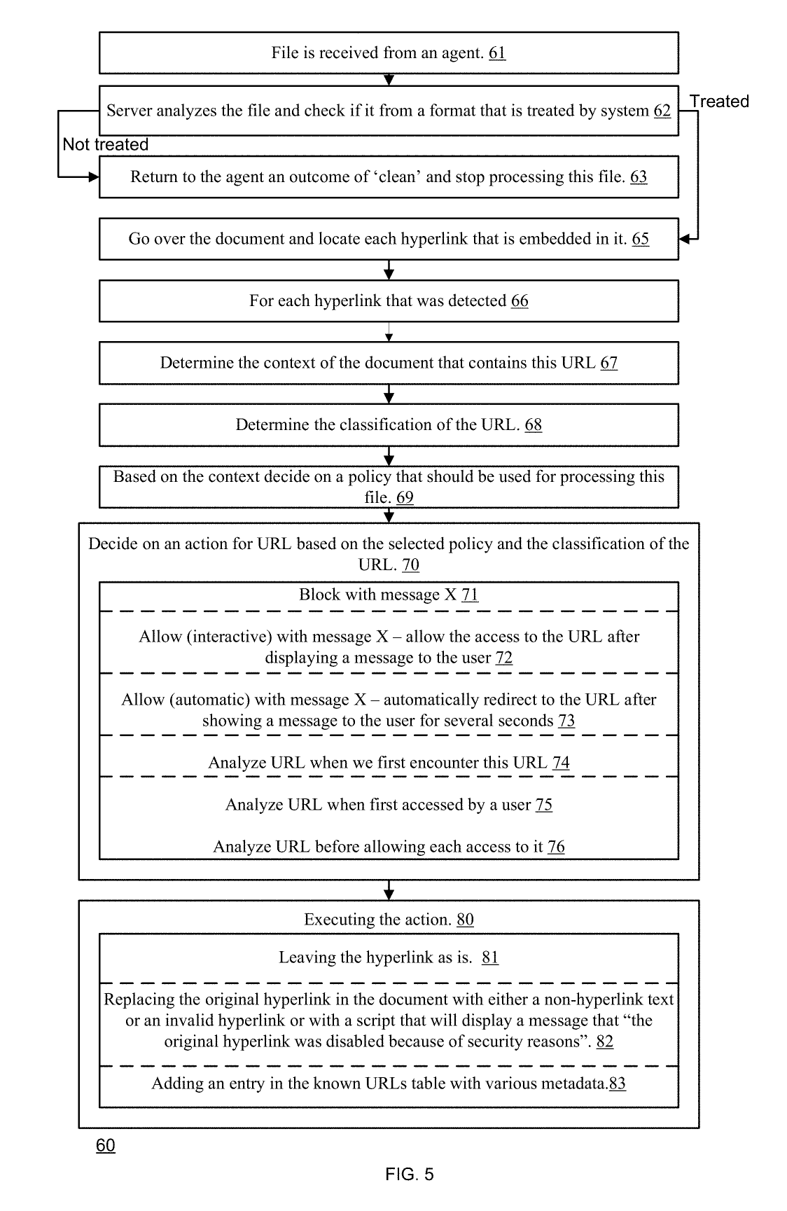

When a new file is received from an agent (step 61 in FIG. 5) the server will analyze (step 62) the file and check if it from a format that is treated by system (e.g. PDF, DOC, DOCX, PPT, PPTX, XLS, XLSX). If the file is not from one of those formats, then return (step 63) to the agent an outcome of ‘clean’ and stop processing this file.

If the file is in one of these formats—Go over the document and locate each hyperlink that is embedded in it (step 65). Detecting the elements of the file is done according to the format of that file. The system contains a module that parses each of the supported file formats.

For each hyperlink that was detected (step 66) perform the following steps:
a. Determine (step 67) the context of the document that contains this URL: the context includes information such as who is the intended recipient of the document, what channel was used for receiving the file, etc.
b. Determine the classification (step 68) of the URL. If it matches the criteria for malicious URLs classify it as ‘malicious’. Otherwise if it matches the criteria for trusted URLs classify it as ‘trusted’. Otherwise if it matches the criteria for untrusted URLs classify it as ‘untrusted’. (the order given here is just an example. In another embodiment of the system the order of the checks may be different).

When classifying the file, the system may use any of the following methods:
a. Match the URL to a predefined URL regular expression. This method may help to identify intranet URLS such as a direction to a page in the internal company's web site, or to a list of known malicious sites.
b. Use an external database of web sites that are known to be malicious or safe. The source of such a list can be a commercial tool (such as McAfee's siteAdvisor) or a community based list.
c. Analyze the web page using a tool such as a sandbox or another malware detection tool. This type of tool reads the content of the web page and looks for dangerous scripts or malware that is offered by the page for downloading.

Based on the context decide on a policy (step 69) that should be used for processing this file.

Decide on an action (step 70) for URL based on the selected policy and the classification of the URL. The chosen action may be one of:
a. Block with message X (step 71).
b. Allow (interactive) with message X—allow the access to the URL after displaying a message to the user (step 72).
c. Allow (automatic) with message X—automatically redirect to the URL after showing a message to the user for several seconds (step 73).
d. Analyze URL when we first encounter this URL (step 74).
e. Analyze URL when first accessed by a user (step 75).
f. Analyze URL before allowing each access to it (step 76).

Step 70 may be followed by executing the action (80).

When the policy dictates to leave the hyperlink as is—then step 80 may include step 81 of leaving the hyperlink as is.

When the policy dictates that the URL should be blocked than step 80 may include step 82 of replacing the original hyperlink in the document with either a non-hyperlink text or an invalid hyperlink or with a script that will display a message that “the original hyperlink was disabled because of security reasons”.

When the policy dictates that the server should redirect the hyperlink to an ad-hoc landing page then step 80 may include step 83 of adding an entry in the known URLs table with the following data:
a. The original destination of the hyperlink.
b. Generate an address (possibly random) on our internal web server that will host the ad-hoc web page. The processed hyperlink will be modified to direct to this address.
c. The action that was chosen for the URL.
d. An empty statistics record (to be used in the future when this page is accessed).

If the selected action for this hyperlink is “Analyze URL when we first encounter this URL” then step 80 may include step 84 of submitting this URL to analysis and store the results in the table when they are ready.

### Web Server

When the server receives a request from a user for a specific web address it looks it up in the table of known addresses according to the generated address field of each entry.

If the known URLs table doesn't contain a matching entry, then return a “404 address not found” error to the caller.

Read the matching entry from the known URL table and act generate a web page according to the designated action there.
a. Block with message X—generate a web page with message X.
b. Allow (interactive) with message X—generate a web page that will display message X and allow the user to reach the original URL.
c. Allow (automatic) with message X—generate a web page that automatically redirect to the URL after showing a message to the user for several seconds.
d. Analyze URL when we first encounter this URL—If the entry still wasn't analyzed then generate a web page that will enter a loop until there is an analysis result ready in the table. When the analysis result for the page is unsafe then block it. Otherwise, allow the user to access the URL.
e. Analyze URL when first accessed by a user—If the entry still wasn't analyzed then generate a request to the server to analyze the URL. Then generate a web page that will enter a loop until there is an analysis result ready in the table (which will happen when the server completes the analysis). When the analysis result for the page is unsafe then block it. Otherwise, allow the user to access the URL.
f. Analyze URL before allowing each access to it—generate a request to the server to analyze the URL. Then generate a web page that will enter a loop until there is an analysis result ready in the table (which will happen when the server completes the analysis). When the analysis result for the page is unsafe then block it.

Otherwise, allow the user to access the URL.

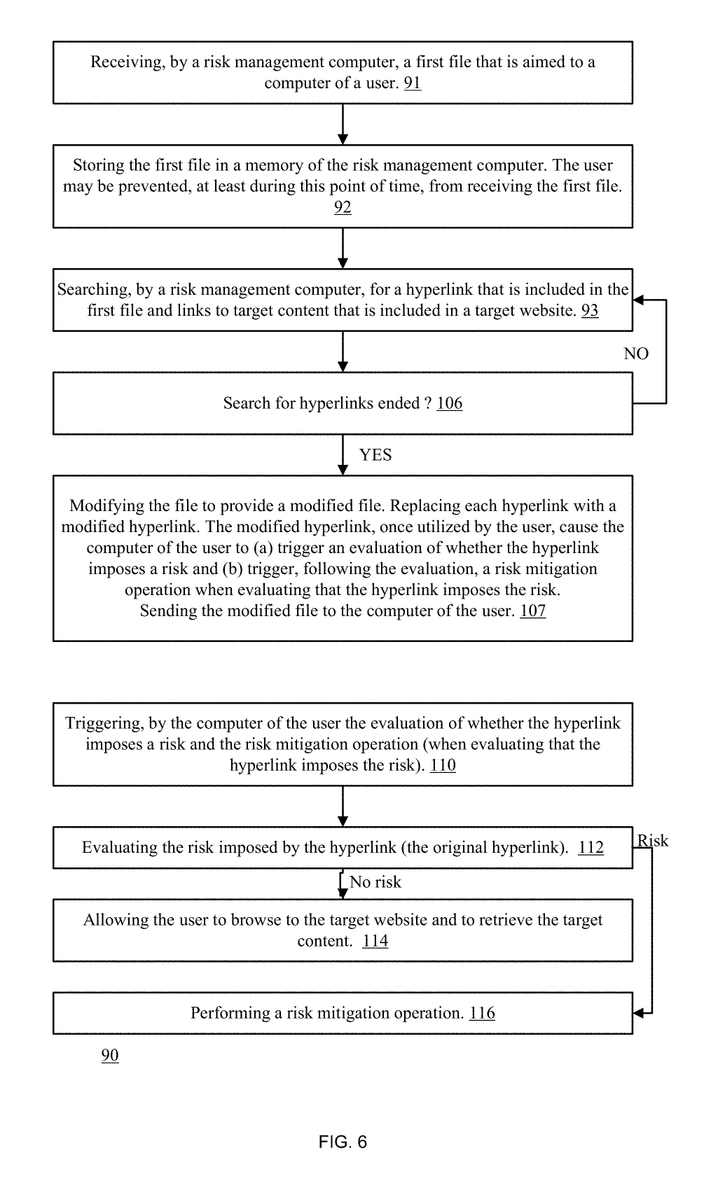

FIG. 6 illustrates method 90 according to an embodiment of the invention.

Method 90 is for malicious hyperlink protection.

Method 90 may start by step 91 of receiving, by a risk management computer (such as server 10 of FIG. 1), a first file that is aimed to a computer of a user.

Step 91 may be followed by step 92 of storing the first file in a memory of the risk management computer. The user may be prevented, at least during this point of time, from receiving the first file.

The term “first” is merely used to distinguish between the first files and other files that may be generated by the risk management computer and/or received by the risk management computer from other computers and/or from other documents received at other points in time.

Step 92 may be followed by step 93 of searching, by a risk management computer, for a hyperlink that is included in the first file and links to target content that is included in a target website.

Step 93 may be followed by step 94 (when the hyperlink was found) of evaluating, at least partially by the risk management computer, whether the hyperlink imposes a risk. The hyperlink may be defined as malicious, unsafe or safe—wherein the first two classifications indicate that the hyperlink imposes a risk—especially that the browsing of the computer of the user to the target website will impose a risk.

It is noted that the risk management computer may classify the risk to more than two risk levels.

Method 90 may also include step 95 of preventing the user from utilizing the hyperlink for accessing the target content before a completion of the evaluating of whether the hyperlink imposes the risk. The user may be prevented from utilizing the hyperlink by preventing the access of the computer of the user to the first file.

When step 94 evaluates that the hyperlink imposes the risk then step 94 is followed by step 96 of modifying the file to provide a modified file.

Step 96 may include step 961 of deleting the hyperlink, and may include step 962 of replacing the hyperlink with a modified hyperlink. The modified hyperlink links to a web entity that differs from the target website.

Step 96 may be followed by jumping to step 93 for searching the next hyperlink in the first file. Step 96 may be followed by step 93 until all the hyperlinks within the first file are found or until any predefined stop condition occurs. For example—method 90 may include preventing the provision of the first file to the computer of the user if risky enough hyperlinks were detected—even before the entire file was scanned for hyperlinks.

Step 96 may be followed (when the stop condition was fulfilled—see step 97) by step 98 of sending the modified file to the computer of the user.

If neither one of the hyperlinks that were scanned during steps 93-96 imposed a risk, then step 94 may be followed by step 99 of sending the first file to the computer of the client.

Steps 99 and/or 98 may be executed by the risk management computer (for example—the server) or by another computer. Steps 99 and/or 98 may be executed at any time after the completion of other steps of method 90.

Step 962 may include (or may be preceded by a step that includes) generating the web entity—which is a landing page. The landing page may include an alert to be displayed to the user when the user utilizes the modified hyperlink.

Step 962 may include (or may be preceded by a step that includes) generating the web entity—which is a landing page. The landing page may include an alert to be displayed when the user utilizes the modified hyperlink. The landing page is associated with a script that includes instructions for accessing the target content that is included in the target website after a predefined delay from a start of the displaying of the alert. The landing page may be associated with the script by being included in the landing page and/or may include a link to the script or any other information and/or metadata that will trigger the execution of the script.

Step 962 may include (or may be preceded by a step that includes) generating the web entity—which is a landing page. The landing page may include a request for confirming an access to the target content in the target website. Thus—when the computer of the user accesses the landing page—the user will see or hear a request to confirm the access to the target content in the target website. The landing page is associated with a script that comprises instructions for accessing the target content in the target website when the user confirmed the access to the target content in the target website.

Step 962 may include (or may be preceded by a step that includes) generating the web entity—which is a landing page. The landing page may include a sanitized version of the target content or comprises a link to the sanitized version of the target content. A sanitized version may be generated by the risk management computer and may include at least some of the target content—in a risk free (or at least risk reduced) format. For example—the sanitized version of the target content is may be non-interactive content of the target content. For example—a non-interactive image of the target content.

Step 962 may include (or may preceded by a step that may include) generating the landing page while concealing from the user a name of the target website. The concealing may include replacing the name of the target website by a string of symbols that may identify the target website to the risk management computer but will identify to the user the name or the target web site.

Step 96 may include generating the modified hyperlink not to include any identifier of the target website.

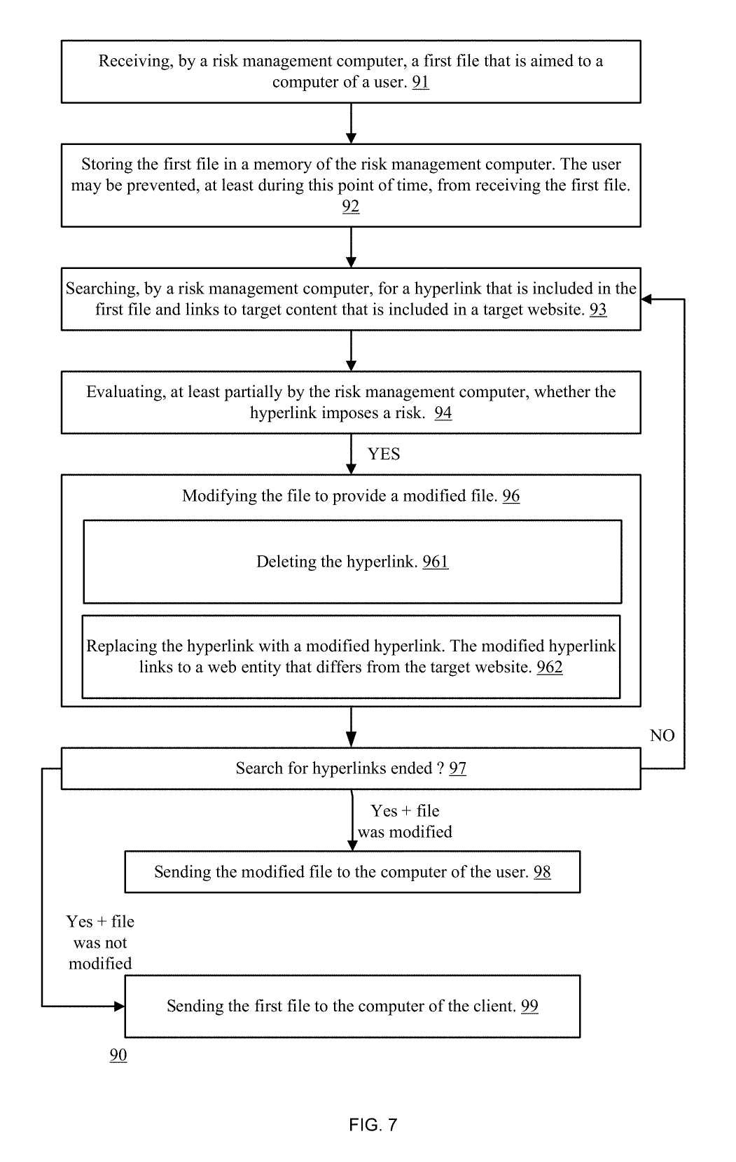

FIG. 7 illustrates method 100 according to an embodiment of the invention.

Method 100 is for malicious hyperlink protection.

Method 100 differs from method 90 by delaying the evaluation of the risk imposed by the hyperlink to a later stage (and delaying the response to the evaluation). The evaluation of the risk imposed by the hyperlink may be executed by the risk management computer, by the computer of the user or by another computer.

Method 100 may start by step 91 of receiving, by a risk management computer (such as server 10 of FIG. 1), a first file that is aimed to a computer of a user.

Step 91 may be followed by step 92 of storing the first file in a memory of the risk management computer. The user may be prevented, at least during this point of time, from receiving the first file.

Step 92 may be followed by step 93 of searching, by a risk management computer, for a hyperlink that is included in the first file and links to target content that is included in a target website.

Step 93 may be followed by step 104 (when the hyperlink was found) of modifying the file to provide a modified file. Step 104 includes replacing the hyperlink with a modified hyperlink. The modified hyperlink, once utilized by the user, cause the computer of the user to (a) trigger an evaluation of whether the hyperlink imposes a risk and (b) trigger, following the evaluation, a risk mitigation operation when evaluating that the hyperlink imposes the risk.

Step 104 may be followed by jumping to step 93 for searching the next hyperlink in the first file. Step 104 may be followed by step 93 until all the hyperlinks within the first file are found or until any predefined stop condition occurs. For example—method 100 may include preventing the provision of the first file to the computer of the user if risky enough hyperlinks were detected—even before the entire file was scanned for hyperlinks.

Step 104 may be followed (when the stop condition was fulfilled—see step 106) by step 107 of sending the modified file to the computer of the user. The file may be modified after finding each hyperlink, after finding a predefined number of hyperlinks or after finding all the hyperlinks. FIG. 7 illustrates a modifying after all hyperlinks were found.

Method 100 may also include step 110 of triggering, by the computer of the user (for example—when the user selected to browse to the address included in the modified link) the trigger evaluation of whether the hyperlink imposes a risk and the risk mitigation operation (when evaluating that the hyperlink imposes the risk).

Step 110 may be followed by step 112 of evaluating (by the computer of the user, by the risk management computer or by another computer) the risk imposed by the hyperlink (the original hyperlink).

When the original hyperlink (the target content within the target website linked by the original hyperlink) does not impose a risk then step 112 may be followed by step 114 of allowing the user to browse to the target website and to retrieve the target content.

When the original hyperlink (the target content within the target website linked by the original hyperlink) does impose a risk then step 112 may be followed by step 116 of performing a risk mitigation operation (by the computer of the user, by the risk management computer or by another computer). Step 116, may include, for example, any one of steps 94 and 96.

It should be noted that step 110 may also be regarded as a risk mitigation operation.

Step 116 may include any of the following:
a. Preventing the computer of the user from accessing the target content in the target web site.
b. Accessing a landing page that comprises an alert to be displayed to the user when the user utilizes the modified hyperlink.
c. Accessing a landing page that comprises an alert to be displayed when the user utilizes the modified hyperlink; wherein the landing page is associated with a script that comprises instructions for accessing the target content that is included in the target website after a predefined delay from the start of the displaying of the alert. The predefined delay may be few seconds, may be set by a user, system operator, may change over time, and the like.
d. Accessing a landing page that comprises a request for confirming an access to the target content in the target website; wherein the landing page is associated with a script that comprises instructions for accessing the target content in the target website when the user confirmed the access to the target content in the target web site.
e. Accessing a landing page that comprises a sanitized version of the target content or comprises a link to the sanitized version of the target content.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product that may be or may include a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for malicious hyperlink protection, the method comprises:
receiving, by a risk management computer, a first file that is aimed to a computer of a user;
storing the first file in a memory of the risk management computer;
searching, by the risk management computer, for a hyperlink that is included in the first file and links to target content that is included in a target website;
when finding the hyperlink then evaluating, at least partially by the risk management computer, whether the hyperlink imposes a risk;
preventing the user from utilizing the hyperlink for accessing the target content before a completion of the evaluating of whether the hyperlink imposes the risk; and
wherein when evaluating that the hyperlink imposes the risk then:
modifying the file to provide a modified file; wherein the modifying of the file comprises deleting the hyperlink or replacing the hyperlink with a modified hyperlink;
wherein the modified hyperlink links to a web entity that differs from the target website; and
sending the modified file to the computer of the user.

2. The method according to claim 1 wherein the web entity is a landing page; wherein the method comprises generating the landing page to comprise an alert to be displayed to the user when the user utilizes the modified hyperlink.

3. The method according to claim 1 wherein the web entity is a landing page; wherein the method comprises generating the landing page to comprise an alert to be displayed when the user utilizes the modified hyperlink; wherein the landing page is associated with a script that comprises instructions for accessing the target content that is included in the target website after a predefined delay from a start of the displaying of the alert.

4. The method according to claim 1 wherein the web entity is a landing page; wherein the method comprises generating the landing page to comprise a request for confirming an access to the target content in the target website; wherein the landing page is associated with a script that comprises instructions for accessing the target content in the target website when the user confirmed the access to the target content in the target website.

5. The method according to claim 1 wherein the web entity is a landing page; wherein the method comprises generating the landing page to comprise a sanitized version of the target content or comprises a link to the sanitized version of the target content.

6. The method according to claim 5 wherein the sanitized version of the target content is a non-interactive content of the target content.

7. The method according to claim 1 wherein the web entity is a landing page; wherein the method comprises generating the landing page while concealing from the user a name of the target web site.

8. The method according to claim 1 comprising generating the modified hyperlink not to include any identifier of the target website.

9. A method for malicious hyperlink protection, the method comprises:
receiving, in a risk management computer, a first file that is aimed to a computer of a user;
storing the first file in a memory of the risk management computer;
searching, by the risk management computer, for a hyperlink that is included in the first file and links to target content that is included in a target website;
when finding the hyperlink then modifying the file to provide a modified file; wherein the modifying of the file comprises replacing the hyperlink with a modified hyperlink; wherein the modified hyperlink, once utilized by the user, cause the computer of the user to (a) trigger an evaluation of whether the hyperlink imposes a risk and (b) trigger, following the evaluation, a risk mitigation operation when evaluating that the hyperlink imposes the risk; and
sending the modified file to the risk management computer of the user.

10. The method according to claim 9 wherein the risk mitigation operation comprises preventing the computer of the user from accessing the target content in the target website.

11. The method according to claim 9 wherein the risk mitigation operation comprises accessing a landing page that comprises an alert to be displayed to the user when the user utilizes the modified hyperlink.

12. The method according to claim 9 wherein the risk mitigation operation comprises accessing a landing page that comprises an alert to be displayed when the user utilizes the modified hyperlink; wherein the landing page is associated with a script that comprises instructions for accessing the target content that is included in the target website after a predefined delay from a start of the displaying of the alert.

13. The method according to claim 9 wherein the risk mitigation operation comprises accessing a landing page that comprises a request for confirming an access to the target content in the target website; wherein the landing page is associated with a script that comprises instructions for accessing the target content in the target website when the user confirmed the access to the target content in the target website.

14. The method according to claim 9 wherein the risk mitigation operation comprises accessing a landing page that comprises a sanitized version of the target content or comprises a link to the sanitized version of the target content.

15. The method according to claim 14 wherein the sanitized version of the target content is a non-interactive content of the target content.

16. A computer program product that stores instructions that once executed by a computer cause the computer to execute the steps of receiving, by a risk management computer, a first file that is aimed to a computer of a user; storing the first file in a memory of the risk management computer; searching, by the risk management computer, for a hyperlink that is included in the first file and links to target content that is included in a target website; when finding the hyperlink then evaluating, at least partially by the risk management computer, whether the hyperlink imposes a risk; preventing the user from utilizing the hyperlink for accessing the target content before a completion of the evaluating of whether the hyperlink imposes the risk; and wherein when evaluating that the hyperlink imposes the risk then: modifying the file to provide a modified file; wherein the modifying of the file comprises deleting the hyperlink or replacing the hyperlink with a modified hyperlink; wherein the modified hyperlink links to a web entity that differs from the target website; and sending the modified file to the computer of the user.

17. A computer program product that stores instructions that once executed by a risk management computer cause the risk management computer to execute the steps of receiving a first file that is aimed to a computer of a user; storing the first file in a memory of the risk management computer; searching for a hyperlink that is included in the first file and links to target content that is included in a target website; when finding the hyperlink then modifying the file to provide a modified file; wherein the modifying of the file comprises replacing the hyperlink with a modified hyperlink; wherein the modified hyperlink, once utilized by the user, cause the computer of the user to (a) trigger an evaluation of whether the hyperlink imposes a risk and (b) trigger, following the evaluation, a risk mitigation operation when evaluating that the hyperlink imposes the risk; and sending the modified file to the risk management computer of the user.

18. A risk management computer that comprises a memory, a communication module and a processor, wherein the memory is configured to receive and store a first file that is aimed to a computer of a user; wherein the processor is configured to search for a hyperlink that is included in the first file and links to target content that is included in a target website; when finding the hyperlink then at least assist in evaluating whether the hyperlink imposes a risk; preventing the user from utilizing the hyperlink for accessing the target content before a completion of the evaluating of whether the hyperlink imposes the risk; and wherein when evaluating that the hyperlink imposes the risk then the processor is configured to modify the file to provide a modified file; wherein the modifying of the file comprises deleting the hyperlink or replacing the hyperlink with a modified hyperlink; wherein the modified hyperlink links to a web entity that differs from the target website; and wherein the communication module is configured to send the modified file to the computer of the user.
